(19) United States
(12) Patent Application Publication
(10) Pub. No.: US 2015/0227509 A1
(43) Pub. Date: Aug. 13, 2015

(54) PROVIDING TRANSLATION OF A TEXT ITEM FROM A DISPLAYED PORTION OF TEXT CONTENT

(71) Applicant: Kobo Inc., Toronto (CA)

(72) Inventor: Benjamin Landau, Toronto (CA)

(73) Assignee: Kobo Inc., Toronto (CA)

(21) Appl. No.: 14/180,088

(22) Filed: Feb. 13, 2014

(51) Int. Cl. G06F 17/28; G06F 17/27; G06F 17/21

(52) U.S. Cl. CPC G06F 17/28; G06F 17/21; G06F 17/275

(57) ABSTRACT

A portion of a text content from a content item is displayed within a display area of a display of a computing device. A text item from the portion of the text content and a target language are identified from user input. A translation of the identified text item is retrieved from a network service in the target language. The translation of the identified text item is displayed within a boundary of the display area and concurrently with the portion of the text content.

### TECHNICAL FIELD

Embodiments described herein relate to an e-reader device, and more specifically, to an e-reader device to provide translation services in an e-book.

### BACKGROUND

An electronic personal display is a mobile electronic device that displays information to a user. While an electronic personal display may be capable of many of the functions of a personal computer, a user can typically interact directly with an electronic personal display without the use of a keyboard. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

An electronic reader, also known as an e-reader, is an electronic personal display that is used for reading electronic books (e-books), electronic magazines, and other digital content. For example, digital content of an e-book is displayed as alphanumeric characters and/or graphic images on a display of an e-reader such that a user may read the digital content much in the same way as reading the analog content of a printed page in a paper-based book. An e-reader provides a convenient format to store, transport, and view a large collection of digital content that would otherwise potentially take up a large volume of space in traditional paper format.

In some instances, e-readers are purpose built devices designed especially to perform especially well at displaying readable content. For example, a purpose built e-reader may include a display that reduces glare, performs well in high light conditions, and/or mimics the look of text on actual paper. While such purpose built e-readers may excel at displaying content for a user to read, they may also perform other functions, such as displaying images, emitting audio, recording audio, and web surfing, among others.

There also exists numerous kinds of consumer devices that can receive services and resources from a network service. Such devices can operate applications or provide other functionality that links the device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system for operating a computing device to provide a translation of a text item when the computing device displays text content, according to an embodiment.

FIG. 2 illustrates an example of an e-reader device or other electronic personal display device, for use with one or more embodiments described herein.

FIG. 3 illustrates an e-book device system for providing a translation of a text item from a displayed portion of text content, according to an embodiment.

FIG. 4 illustrates a computer-implemented method for providing a translation of a text item from a displayed portion of text content, according to at least some embodiments.

FIG. 5 illustrates an interface that is displayed on an e-reader device or other electronic personal display device in accordance with an embodiment.

### DETAILED DESCRIPTION

Examples described herein include a computing device that displays text content from a content item, and further displays translations of selected text items within the structure, context, or boundary of the text content.

In examples described herein, a content item from which text items can be translated can have a predefined structure and format. By way of example, a content item can correspond to an e-book (including electronic magazines or comic books) having pagination and/or chapter designations, and a format such as Electronic Publication (“EPUB”), APABI, Hypertext Markup Language (“HTML”), iBOOK, KF8, MICROSOFT LIT, AZW, or Digital Accessible Information System (“DAISY”). In variations, the content item can correspond to a document having pagination and/or chapter designations in formats such as Portable Document Format (“PDF”) or Plain text files.

In an embodiment, a computing device displays a portion of a text content from a content item. User input selects a text item and a target language. The computing device retrieves a translation from a network service of the identified text item in the target language. The computing device displays the translation of the identified text item within a boundary of the display area and concurrently with the portion of the text content.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System and Device Description

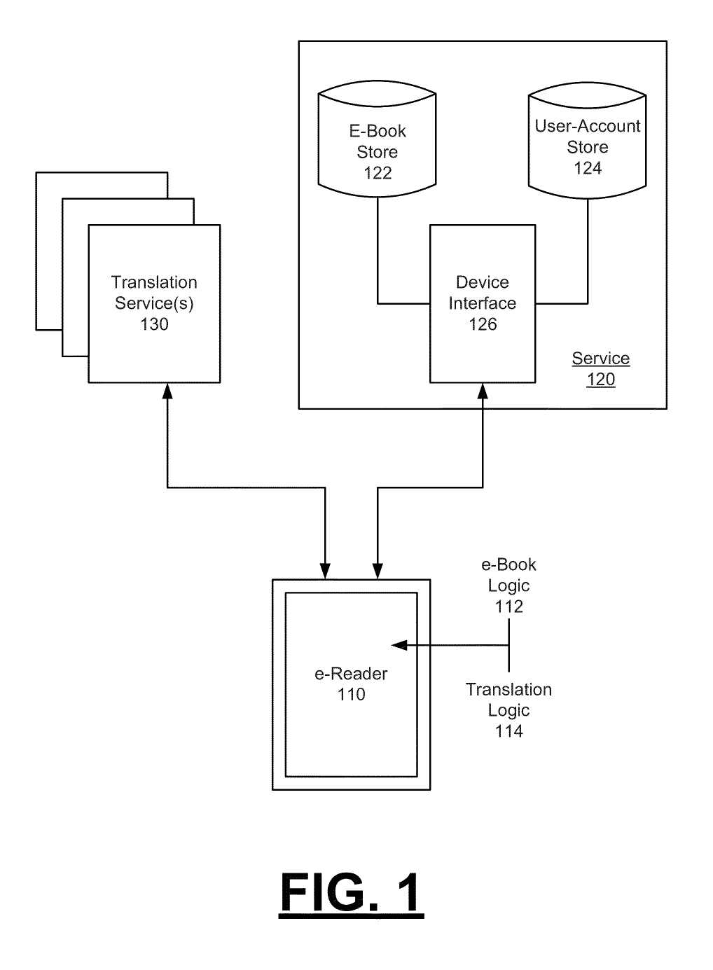

FIG. 1 illustrates a system for operating a computing device to provide a translation of a text item when the computing device displays text content, according to an embodiment. In an example of FIG. 1, the system includes an electronic display device, shown by way of example as an e-reader device 110, a network service 120, and one or more translation services 130. The e-reader device 110 can communicate with the network service 120 and the one or more translation services 130 over one or more networks (e.g., wirelessly). The network service 120 may include multiple servers and other computing resources that provide various services in connection with one or more applications that are installed on the e-reader device 110. By way of example, in one implementation, the network service 120 provides e-book services, which communicate with the e-reader device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reader device 110 can correspond to any electronic personal display device on which applications and application resources (e.g., e-books, media files, documents) can be rendered and consumed. In one example, the e-reader device 110 corresponds to a tablet or a telephony/messaging device (e.g., smart phone). For example, the e-reader device 110 can have a tablet like form factor, although variations are possible. In some cases, the e-reader device 110 can also have an E-ink display.

In one example, the e-reader device 110 also runs an e-reader application that links the device to the network service 120 and enables e-books provided through the service to be viewed and consumed. An e-book can correspond to a publication or a document in digital form, comprising text and/or graphics, which can be displayed on the e-reader device 110. In another implementation, the e-reader device 110 can run a media playback or streaming application which receives files or streaming data from the network service 120. By way of example, the e-reader device 110 can be equipped with hardware and software to optimize certain application activities, such as rendering of electronic content (e.g., e-books). Although examples described herein refer to e-books, the e-reader device 110 can display other types of documents, such as a .pdf file, a .doc file, a .txt file, etc., and in general, can display other content items that include text content.

In additional detail, the network service 120 can include a resource store 122, a user account store 124, and a device interface 126. The resource store 122 can store a plurality of documents, such as e-books, to be accessed by one or more e-readers 110 that are registered or subscribed with the network service 120. The user account store 124 can store information that associates the e-reader device 110 with a user and with an account. The account can also be associated with one or more application resources or content items (e.g., e-books), which can be stored in the resource store 122. The device interface 126 enables the e-reader device 110 to communicate with the network service 120.

As described further, the user account store 124 can retain metadata for individual accounts to identify resources that have been purchased or made available for consumption for a given account. The e-reader device 110 may be associated with the user account, and multiple devices may be associated with the same account. As described in greater detail below, the e-reader device 110 can store content items (e.g., e-books) that are purchased or otherwise made available to the user of the e-reader device 110, as well as to archive e-books and other digital content items that have been purchased for the user account, but are not stored on the particular e-reader device 110.

With further reference to FIG. 1, the e-reader device 110 can include e-book logic 112 and translation logic 114. The e-book logic 112 operates to enable a user of the e-reader device 110 to access, view, and/or edit a collection of digital content items belonging to a user (e.g., digital content items that the user has purchased for download, licensed, or otherwise obtained a right of possession). The e-book logic 112 can also operate to communicate with the network service 120 to browse, view, and/or purchase, license, or obtain rights to other content items. In some examples, the e-book logic 112 also operates to display graphic representations of individual content items. For example, the e-book logic 112 can display icons representing album covers, movie titles, and television shows. In the context of e-books, the e-book logic 112 displays icons representing book covers or jackets, magazine covers, comic book covers etc., corresponding to content items belonging to the user. The e-book logic 112 can provide multiple organizational structures for displaying graphic representations of content items, such as in lists, folders, or virtual structures, such as bookshelves (for e-books). The e-book logic 112 enables the user to select a content item, such as an e-book, and displays a portion of text content (and/or graphic content) of the selected content item (e.g., display a page of the e-book in a paginated view) on a display of the e-reader device 110.

The e-reader device 110 can include translation logic 114, which operates to communicate with one or more translation services 130 in order to provide translations of text content from a content item, such as an e-book. According to one or more embodiments, the translation logic 114 obtains a translation of a text item that is identified by user input. A text item can correspond to one or more alpha-numeric characters, a word, multiple words, a phrase, a sentence, multiple sentences, a paragraph, multiple paragraphs, an entire displayed portion of text content of a content item or page of an e-book, etc. For example, the user can select or highlight a sentence while viewing a page of an e-book. The translation logic 114 can identify the text item based on the user input or selection.

In one embodiment, the translation logic 114 communicates with one or more translation services 130 to retrieve or receive a translation of the identified text item in a specified language. The translation service(s) 130 can include one or more servers or computing resources that provide a translation for text from one language to another. More generally, according to some examples, a translation service 130 can correspond to an online translation resource that is accessible by the e-reader device 110 via the translation logic 114. The translation logic 114 can transmit the identified text item in response to user input, retrieve a translation of the identified text item in a specified language, and display, concurrently with the portion of the text content of the content item, the translation on the e-reader device 110. In this manner, the user of the e-reader device 110 can obtain a translation of a text item from the content of an e-book that the user is reading. Additionally, the user can view the translation for the selected text on within the boundary, structure or context of a displayed page of the e-book.

Hardware Description

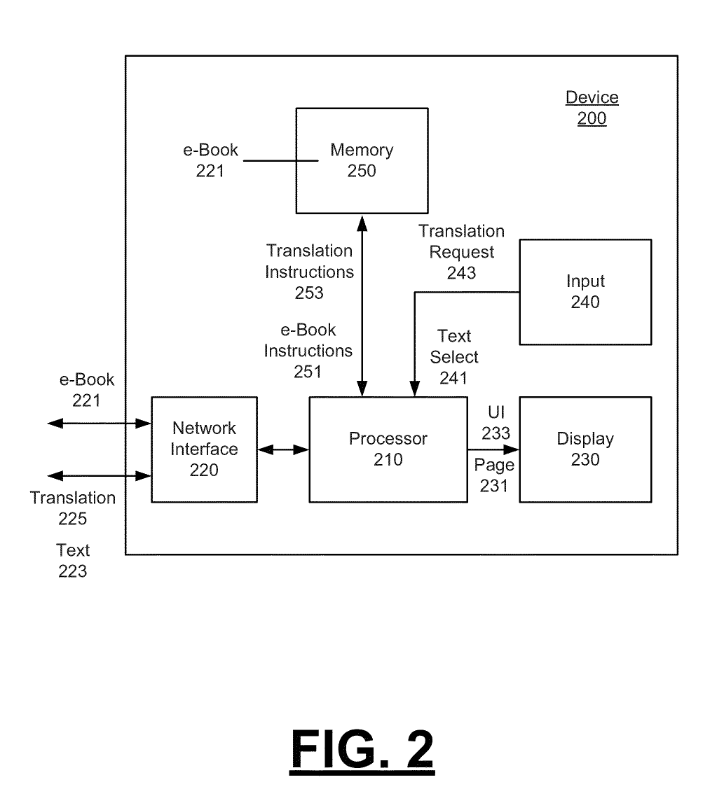

FIG. 2 illustrates an example of an e-reader device or other electronic personal display device, for use with one or more embodiments described herein. In an example of FIG. 2, an e-reader device 200 corresponds to, for example, the e-reader device 110, such as also shown by an example of FIG. 1. With reference to FIG. 2, the e-reader device 200 includes a processor 210, a network interface 220, a display 230, one or more input mechanisms 240, and a memory 250.

The processor 210 can implement functionality using instructions stored in the memory 250. Additionally, in some implementations, the processor 210 utilizes the network interface 220 to communicate with the network service 120 and one or more translation services 130 (see FIG. 1). More specifically, the e-reader device 200 can access the network service 120 to receive various kinds of resources (e.g., digital content items, such as e-books, configuration files, account information), as well as to provide information (e.g., user account information, service requests, etc.). For example, the e-reader device 200 can receive content items, such as e-books 221 or media files that the user elects to purchase and/or otherwise download from the network service 120. The content items that are downloaded onto the e-reader device 200 can be stored in the memory 250.

In some implementations, the display 230 can correspond to, for example, a liquid crystal display (LCD) or light emitting diode (LED) display that illuminates in order to provide content generated from the processor 210. In some examples, the display 230 can be touch-sensitive. In some variations, the display 230 can correspond to an electronic paper type display, which mimics conventional paper in the manner in which they display content. Examples of such display technologies include electrophoretic displays, electrowetting displays, and electrofluidic displays.

The processor 210 can receive input from various sources, including from one or more input mechanisms 240 (e.g., buttons or switches, microphone, keyboard, etc.), the display 230 (e.g., soft buttons or keyboard of a touch-sensitive display), or other input mechanisms (e.g., accessory devices that are connected to the e-reader device 200 via a cable or via a wireless communication medium, such as Bluetooth). The processor 210 can receive user input and based on the user input, identify a content item (e.g., e-book 221) for display and display a portion of text content of the content item on the display 230. The user can interact with the displayed e-book 221 (e.g., change pages, make bookmarks, etc.) by providing additional user inputs.

With further reference to FIG. 2, the memory 250 can store instructions 251 for implementing e-book logic 112 (see FIG. 1) and instructions 253 for implementing translucency logic 112 (see FIG. 1). As discussed, application resources, such as content items (e-books 221), can be received by the network interface 220 from, for example, the network service 120 and stored in the memory 250. Each e-book 221 can include a metadata set and content portion. The metadata set can include, for example, the graphic representation of the e-book 221, such as an iconic representation of a book cover, as well as summary information, author, title, short synapse, language of the e-book, etc. In one implementation, the processor 210 executes the e-book instructions 251 for implementing the e-book logic 112 to display a selected e-book on the display 230. For example, the processor 210 implements the e-book logic 112 to display, within a display area of the display 230, a portion of a text content (e.g., a page 231) from the content item (e.g., the e-book 221). The e-book instructions 251 for implementing the e-book logic 112 can use input provided by a user via user interaction with the input mechanism 240 and/or display 230 (e.g., touchscreen input) to identify the e-book 221 from the memory 250 (e.g., the user selects a graphic corresponding to a cover of the e-book 221 from a bookshelf user interface view) and to display the e-book 221 (e.g., a page 231) on the display 230.

The processor 210 also implements the e-book logic 112 to provide different options and features for the user. The user can interact with one or more selectable features or icons to cause the e-reader device 200 to perform additional operations (e.g., operations other than just displaying content), such as note taking, highlighting, searching, looking up a definition, sharing information with other users, etc. For example, the processor 210 implements the e-book logic 112 by executing the e-book instructions 251 to display a portion of text content (e.g., a page 231) of a content item (e.g., a document or an e-book 221) on the display 230. The processor 210 also executes the e-book instructions 251 to receive user input, such as a user input to select or highlight a text item from the displayed portion of text content (e.g., text select input 241).

According to some examples, the processor 210 can provide a control bar user interface to be displayed (e.g., overlaying the displayed portion of text content) on the display 230 in response to receiving a text select input 241. In one example, the e-book logic 112 can determine a position of the selected text item and display the control bar user interface adjacent to (e.g., above, below, or next to) the selected text item so as to not obscure the selected text item. When the user selects or highlights a text item from the displayed portion of text content, the control bar user interface can be displayed to enable the user to make one or more selections for performing additional operations with respect to the selected text item. In one example, an option or icon that is provided (e.g., provided separately or with the control bar user interface) on the display 230 can include a translation request.

The user can select a translation icon corresponding to a translation request 243, e.g., by tapping on the touchscreen, to make a translation request. In at least one example, in response to receiving the translation request 243, the processor 210 can execute the translation instructions 253 for implementing the translation logic 114 in order to provide a translation of an identified text item of a portion of text content for the user (e.g., the text item selected or highlighted by the user). In particular, the processor 210 executes the translation logic 114 to identify, from user input, a text item (e.g., a word, a phrase, a sentence, a paragraph, etc.) from a displayed portion of text content that is to be translated from a first language to a second language. The processor 210 can also determine, from user input, that the selected text is to be translated in a target language.

In one example, the processor 210 can implement the translation instructions 253 for the translation logic 114 so that a graphic user interface(s) 233 is displayed with the displayed portion of text content. For example, when the user provides an input corresponding to a translation request 243, the processor 210 can cause a translation panel user interface to be displayed within a boundary of the display area and concurrently with the portion of the text content. Specifically, in one example, the processor 210 can display the translation panel user interface on the display 230 so that the translation panel user interface does not obscure the identified or user-selected text item.

According to an example, the processor 210 can display the translation panel user interface within the boundary of the display area in which the portion of the text content from a content item is displayed. In one example, the translation panel user interface can include a language selection option that, when selected by a user via a user input, displays a menu showing one or more language options. The processor 210 can implement the translation instructions 253 for the translation logic 114 to enable the user to select a language option, which causes the translation logic 114 to communicate with one of the translation service(s) 130 (see FIG. 1). For example, when the user selects the language option for “French,” the processor 210 can transmit, over the network using the network interface 220, the identified or selected text item 223 to a translation service 130 (e.g., as data or as a digital stream). The processor 210 can receive the translation 225 of the text item 223 via the network interface 220. In addition, by implementing the translation logic 114, the processor 210 can display the translation 225 of the text item 223 concurrently with the portion of the text content in which the text item 223 was selected. According to an example, the translation 225 can be displayed with the translation panel user interface.

In this manner, the e-reader device 200 can enable a user to translate text (e.g., even a large section of text, such as a paragraph) for display within the context and structure of the displayed portion of the text content. The user is not navigated away from a page 231 of the e-book 221, for example, but can view the selected text 223 that the user wants to translate concurrently with the translation 225 of that text 223. In addition, as a result of copyright laws and agreements, an e-reader device 200 may be legally prevented from enabling a user to copy text from a content item and then paste the copied text into a translation window or user interface provided by a translation service. By executing the e-book instructions 251 and the translation instructions 253, the processor 210 can provide a translation mechanism for the user that complies with copyright requirements, as the identified or selected text is never reproduced in another window or user interface outside of the context and structure of the content item (or currently displayed page of an e-book).

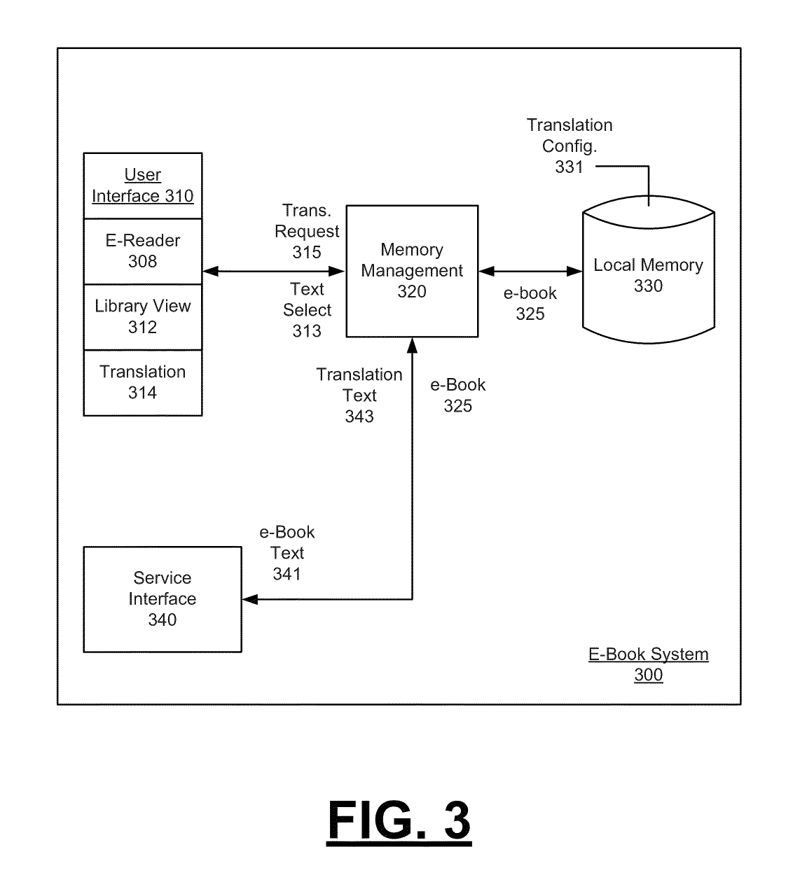

FIG. 3 illustrates an e-book device system for providing a translation of a text item from a displayed portion of text content, according to an embodiment. With reference to FIG. 3, an e-book system 300 implements programmatic components for communicating with an e-book service (such as network service 120, shown in FIG. 1) and one or more translation services (such as a translation service 130, shown in FIG. 1), as well as for enabling functionality for viewing and accessing e-books utilized by an account associated with the e-reader device 110 (see FIG. 1 or FIG. 2). In some embodiments, system 300 can be implemented as an application that runs on an e-reader device, such as shown with examples of FIG. 1 or FIG. 2.

According to an example of FIG. 3, system 300 includes a user interface 310, a memory management module 320, a local memory 330, and a service interface 340. Some or all of the programmatic components shown with the computing system 300 can be provided in part as operating system-level components. Alternatively, the programmatic components shown with system 300 can be provided as part of an application that runs on, for example, the e-reader device 110 of FIG. 1. For example, the user can download an application onto the e-reader device 110 to obtain functionality such as described with an example of FIG. 3. Alternatively, the application can be embedded or otherwise pre-installed with other programmatic elements for providing functionality such as described with system 300. Although examples described herein refer to system 300 being implemented on an e-reader device 110 of FIG. 1 or an e-reader device 200 of FIG. 2, in other examples, at least one or more of the programmatic components can be implemented on other devices, such as on another computing device that is in communication with the e-reader device (e.g., a paired or peer-to-peer device), or on one or more computing devices associated with the network service 120 and/or a translation service 130.

The service interface 340 includes application logic which enables the e-reader device 110 to use, for example, a wireless Internet connection, to connect to the network service 120 and one or more translation services 130 (see FIG. 1). In connecting with the network service 120, the service interface 340 can transmit data that enables the network service 120 to identify the e-reader device 110 on which system 300 is implemented (e.g., using a device identifier), so that the network service 120 can determine the account that is associated with the particular e-reader device 110. The service interface 340 can be used to retrieve and/or download one or more content items (e.g., e-books 325) from the network service 120 and store the one or more content items in the local memory 330.

For example, in identifying the e-reader device 100 of system 300 to the network service 120, the network service 120 may be able to procure payment information (e.g., stored credit card information) that can be used to charge the user's account when the user purchases a new e-book 325 from the network service 120. Each e-book 325 can correspond to a literary work having a pagination format and a predefined structure. Optionally, some e-books may have chapter designations, as well as content that corresponds to graphics or images (e.g., in the case of magazines, children's books, comic books, etc.). Individual e-books 325 can also include metadata, such as imagery provided as a cover for the e-book 325 when the e-book 325 is marketed (e.g., similar to the manner in which a conventional hardbound book would be marketed in a retail store) or other information, such as publication date, date the e-book was made available, author information, language, etc. In one implementation, the network service 120 can retrieve or otherwise identify the imagery and other metadata of individual e-books from publisher sources.

In addition, in identifying the e-reader device 110 of system 300, the network service 120 can also identify what e-books 325 belong to the account of that device (e.g., have been purchased or downloaded). The e-books 325 that are transmitted to the e-reader device 110 of system 300 include those that are purchased from the e-reader device 110 or those that the user requested to download. In variations, e-books 325 can automatically be downloaded to the e-reader device 110 in response to occurrence of certain conditions. For example, the user can purchase an e-book on another device, and then subsequently connect the e-reader device 110 to the network service 120 to automatically receive their previously purchased e-book. Alternatively, as another example, the network service 120 can be configured to push e-books 325 to the e-reader device 110 of system 300, based on, for example, user account settings, subscription plans and rules, and/or various other business logic considerations.

Additionally, the service interface 340 can include processes for automatically receiving updates from the network service 120. The update(s) can include programmatic updates, including updates to existing programmatic components on the e-reader device 110, as well as updates to lists, e-books 325 that the user may have purchased on another device of the same account, recommendations from the network service 120 as to what a given user may want to purchase or view, and/or various other data that can be either generally provided to the user of the network service 120 or specifically provided for to the particular account or user.

According to some embodiments, the local memory 330 stores each e-book 325 as a record that includes metadata and content (e.g., page content). The memory management module 320 can retrieve portions of individual e-books 325 for purpose of rendering e-books via the user interface 310.

Among other functionality, the user interface 310 can include an e-reader component 308, a library view component 312, and translation component 314. The e-reader component 308 operates to display content corresponding to, for example, a portion of text content and/or graphic content from a content item (e.g., a paginated content from an e-book 325). The e-reader component 308 can also detect and respond to user inputs. The e-reader component 308 can allow user interaction with the displayed portion of content by enabling the user to view other portions of content via user input or by providing prompts or features for enabling the user to enter inputs. An example of a user input is a page event that corresponds to the user transitioning from one page to the next, or from one page by cluster to another, or transitioning from chapter to chapter. The memory management module 320 can receive user inputs, such as the page event input, and update the paginated content that the user views based on the page event.

Another example of a user input is a text select input 313 that corresponds to the user selecting or highlighting a text item from the displayed portion of the text content. For example, the user can interact with the displayed portion of text content using a touchscreen of the e-reader device 110 to select or highlight a text item. The e-reader component 308 can provide, in response to detecting the user's selection input, a control bar or selectable features concurrently with the displayed portion of text content to enable the user to perform additional operations. Additional operations can include performing a translation, note taking, searching, looking up a definition, sharing information with other users, etc., in relation to the selected text item. In one example, the e-reader component 308 can provide a selectable feature that corresponds to a translation request (e.g., as part of the control bar).

The library view component 312 can display graphic representations and other information of individual e-books 325 in the user's collection. For example, the library view component 312 can use the metadata associated with the records of the e-books 312 in the user's account to display lists, folders, or other virtual structures that include graphic representations and/or other identifiers of e-books 325 in the user's collection. The user's collection can include e-books 325 that the user has on the particular device (e.g., locally stored e-books 325), as well as e-books 325 that may not be locally stored, but are associated with the user account (e.g., read on another device, archived, etc.).

In one implementation, the local memory 330 can include records for each e-book 325 in the user's account, and each record 326 can include its metadata. The user may have the content portion of select e-books 325 archived, so as not to reside in the local memory 330, but be provided by the network service 120 as requested or needed. By way of example, the library view component 312 can display the e-books 325 of a user's collection using a virtual book shelf or bookcase feature in which the e-books 325 are provided. In such an implementation, the e-books 325 are displayed as icons that include imagery, title information, etc. In a variation, the library view component 312 can display representations of e-books 325 in the user's collection as icons, or as icons with associated text. Still further, folders can be used to provide a panel view of the graphic representations (e.g., icons and/or text) of the e-books 325 in the user's collection.

The translation component 314 can operate to display features for enabling a user to select a language for translating text and to display a translation concurrently with a displayed portion of a text content from a content item (e.g., an e-book 325). According to an example, the translation component 314 can display a translation panel in response to the user selecting a selectable feature that corresponds to a translation request. The selectable feature can be displayed (e.g., as part of the control bar or individually) in response to a user selecting a text item from the displayed portion of the text content (e.g., in response to text select input 313). The translation panel can enable the user to choose a language option in which to translate the text item and receive a user input for a translation request 315.

For example, the translation panel can include a feature that, when selected by the user, displays a menu showing one or more language options (e.g., Spanish, French, German, Portuguese, etc.). The user can select one or more of the language options that specifies what language(s) to translate the selected text item to. According to at least one example, the user can also configure the menu and the language options based on user preference. The user can interact with a settings user interface displayed by the user interface 310, for example, in order to provide inputs to the memory management 320 specifying (i) which language option(s) that is to be displayed in the menu, (ii) which translation service(s) is to perform the translation as a whole or for individual language options, and/or (iii) the number of language options that are to be displayed in the menu. The language settings can be stored as translation configuration data 331 in the local memory 330.

The memory management 320 can use the translation configuration data 331 to cause the translation component 314 to display the appropriate features with the translation panel. In one example, the memory management module 320 can receive the translation request 315, identify the selected text item, and perform a translation of the text item by communicating with one or more translation services 130 using the service interface 340, as described below.

When the memory management module 320 receives the translation request 315, the memory management module 320 can identify the user-selected text item from the displayed portion of the text content. In addition, according to an example, the memory management module 320 can also receive, along with the translation request 315 or separately, a target language in which to translate the text item to. The memory management module 320 can communicate with one or more translation services 130 (specified by the translation configuration data 331) via the service interface 340 in order to use the one or more translation services 130 for performing the translation. A translation service 130 can perform the translation on behalf of system 300.

In some cases, a translation service 130 can require that a first language (a translating-from language) and a second language (a target translating-to language) are to be specified. For example, the first language specified can be English and the second language specified can be German, which instructs a translation service 130 that the specified text item is currently in English and needs to be translated to German. Depending on implementation, the memory management module 320 can determine the language of the selected text item by (i) using metadata of the content item, which can specify the language the content item is written in, (ii) using information stored for the e-reader device 110, which can specify the language that the e-reader device 110 operates in, (iii) using information specifying a default translate-from language that is configured by a user, and/or (iv) using other information. In one example, the memory management module 320 can transmit a translation request on behalf of system 300 to the appropriate translation service 130 that is capable of providing the translation to the target language. The translation request can be transmitted with the selected text item 341 (e.g., as a digital stream) and the target language (and if required by the translation service 130, the translate-from language).

After the translation service 130 performs the translation of the selected text item 341 in the target language, the translation service 130 can provide the translation 343 of the text to system 300. The service interface 340 can receive the translation 343 and provide the translation 343 to the memory management module 320. The memory management module 320 can update the displayed translation panel via the translation component 314 to display the translation 343 along with the displayed portion of the text content of the content item.

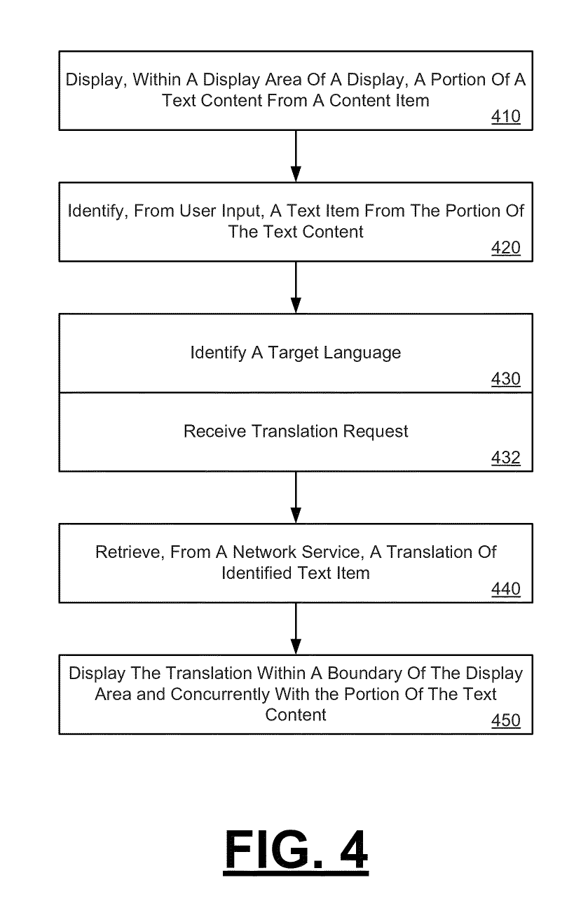

FIG. 4 illustrates a computer-implemented method for providing a translation of a text item from a displayed portion of text content, according to at least some embodiments. A method such as described by an example of FIG. 4 may be implemented using components such as described with an example of FIG. 1, FIG. 2, and/or FIG. 3. Accordingly, reference may be made to elements of other figures for purpose of illustrating an example of a suitable component for performing a step or sub stepping described.

With reference to FIG. 4, a computing device (e.g., e-reader device 110) can display graphic representations of a content item on a display of the computing device, such as a portion of a text content from the content item (410). For example, a content item can have a predefined structure and format, in which portions of text and/or graphic content of the content item can be displayed as a graphic representation. In one example, the content item can correspond to an e-book, and a portion of text content can be displayed (e.g., a page of the e-book) within a specified display area of the display.

The computing device can identify, from user input, a text item from the portion of the text content (420). The user can interact with the touchscreen display of the computing device, for example, to select or highlight a text item. The text item can correspond to a character, a word, multiple words, a phrase, a sentence, a paragraph, an entire page of words, etc. from the displayed portion of the text content. According to some examples, when the user selects or highlights a text item, the computing device can display features for performing operations on the computing device. An operation can correspond to translating text from one language to another.

Based on the user input, the computing device can identify a target language in which to translate the identified text item (430). For example, the computing device can display concurrently with the displayed portion of the text content, one or more features to enable the user to select a language from a plurality of languages. The user can select a language as a target language in which to translate the identified text item. The computing device can also receive the translation request (432). Depending on implementation, the translation request can be received when the user selects a target language. In one example, when the user selects a language, such as French, the computing device can receive the user selection as corresponding to both the language selection as well as the translation request.

As an example, in response to the computing device identifying a text item from user input, the computing device can determine a position of the selected text item with respect to the rest of the displayed portion of the text content within the display area. Based on the position of the selected text item, the computing device can display a control bar and/or a translation panel user interface within the boundary of the display area so as to not obscure the selected text item. The translation panel user interface can display a menu that includes a plurality of selectable language options that the user can select as a target language.

The computing device can communicate with one or more translation services in order to retrieve or receive a translation of the identified text item (440). In some examples, the computing device can transmit, to a translation service, information about the translation request, such as the initial language, the target language, and the text item that is to be transmitted. The translation service can perform the translation and transmit the translated text back to the computing device. The computing device can display the received translation within the boundary of the display area (in which the portion of the text content is displayed) and display the translation concurrently with the displayed portion. In this manner, the user can operate the computing device to translate text without having to copy or cut and paste the requested text item into another window or interface. The computing device can provide the translation within the current page of an e-book, for example, so that the translation is provided within the context and structure of the displayed page.

User Interface Example

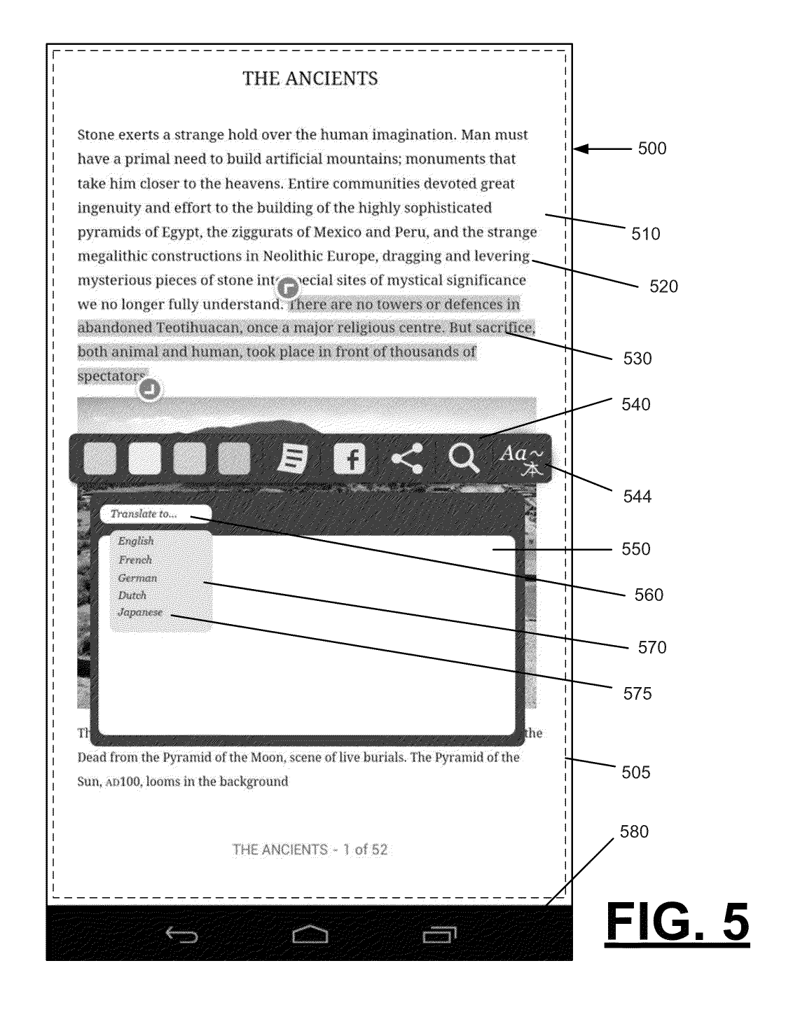

FIG. 5 illustrates an interface that is displayed on an e-reader device or other electronic personal display device in accordance with an embodiment. The user interface shown in FIG. 5 can be displayed by the e-reader device using components such as described with an example of FIG. 1, FIG. 2, and/or FIG. 3.

The e-reader device can display the user interface of FIG. 5 using the display 500 of the e-reader device. In one example, the display 500 can be a touchscreen display that can receive user input via contact with the touchscreen. The e-reader device can display a portion of text content 510 from a content item within a display area of the display 500, as indicated by the boundary 505 of the display area. For example, the display 500 can display a device interface feature 580 (for enabling user control of the e-reader device, which includes a back feature or a home feature) concurrently with (and outside of) the display area in which the portion of the text content 510 is displayed. In the example described in FIG. 5, the content item can correspond to an e-book (e.g., having a title “The Ancients”) and the displayed portion of text content 510 can correspond to a page of the e-book that is being currently viewed by a user of the e-reader device.

The portion of text content 510 can include a plurality of text 520. In addition, the displayed portion can also include graphic content as well as page numbers. The e-reader device enables the user to interact with the displayed portions of content items in order to perform other operations on the e-reader device. For example, as shown in FIG. 5, the user has selected a text item 530 from the displayed portion of text content 510. In this example, the selected text item 530 corresponds to a plurality of sentences. The e-reader device can highlight or distinguish the selected text item 530 from the remainder of the displayed portion of text content 510 using one or more of a different color (e.g., blue, red, yellow, orange, etc. that is different than the background color of the displayed portion), a different pattern (e.g., underline, bold, and/or italicize the characters), a different size (e.g., make the selected text item 530 larger than the other characters), and/or a different font, etc. By distinguishing the selected text item 530 from the remainder of the displayed portion of text content 510, the user can easily determine what he or she has selected from the displayed portion of text content 510. In another example, such as illustrated in FIG. 5, the e-reader device can mark the start and end of the selected text item 530, such as using demarcation icons. Depending on implementation, the individual demarcation icons can be selectable.

According to an example, in response to identifying the text item 530 (e.g., in response to the user highlighting the text item 530), the e-reader device can display a control bar 540 concurrently with the displayed portion of the text content 510. In another example, the e-reader device can display the control bar 540 in response to another user input, such as the user selecting a demarcation icon after selecting the text item 530. According to some examples, the e-reader device can also determine the position of the selected text item 530 and determine where to position the control bar 540 on the display 500 so as to not obscure the selected text item 530 (if possible). For example, if the user selects a large amount of text or the entire portion of text content, the e-reader device will display the control bar 540 to obscure the selected text item 530. The control bar 540 can provide a plurality of features for performing additional operations on the e-reader device in the context of the displayed portion of the text content 510.

For example, the additional operations can include performing a translation, note taking, searching, looking up a definition, sharing information with other users, etc., in relation to the selected text item 530. The control bar 540 can include a translate feature or icon 544 that can be selected by the user to perform a translation of the selected text item 530. In one example, when the user selects the translate icon 544, the e-reader device can display a panel 550 adjacent to the control bar 540. The e-reader device can display the panel 550 by determining the position of the selected text item 530 and determine where to position the panel 550 so as to not obscure the selected text item 530 (if possible).

In the example of FIG. 5, the panel 550 can be initially displayed without the translated text so that the user can select the language select option 560 to view a menu 570 of a plurality of language options 575. For example, the menu 570 can display five different selectable language options 575 (e.g., English, French, German, Dutch, and Japanese). When the user selects one of the language options 575, the e-reader device can communicate the text item 530 (e.g., as a digital stream) to a translation service requesting a translation of the text item 530 in the selected target language. The e-reader device can then display the translated text in the panel 550. In an alternative implementation, when the user selects one of the language options 575, another selectable feature (e.g. “Translate”) can be displayed in the panel 550 to enable the user to request the translation.

As an alternative, the user selecting the translate icon 554 can cause the panel 550 to be displayed to include the translated text in a default or pre-configured target language. The user can specify, for his or her e-reader device, that all translation requests be made in a particular target language. In this manner, when the user selects the translate icon 554, the e-reader device can communicate with the translation service to translate the selected text item 530 without having the user to select the target language manually every time. In another example, the default or pre-configured target language can be displayed in the language select option 560 so that the user's preferred language, e.g., “French,” can be displayed in the language select option 560 instead of “Translate to . . . ,” as shown in FIG. 5.

Although the example discussed with FIG. 5 illustrate a control bar 540 and a panel 550, other user interfaces can be used to display a translation request feature and to display an interface in which translated text can be displayed.

In this manner, the e-reader device can enable a user to translate text for display within the context and structure of the displayed portion of the text content 510. The user is not navigated away from the current view or page of the e-book, for example, but can view the selected text 530 that the user wants to translate concurrently with the translation of that text 530. The e-reader device can provide a translation mechanism for the user that complies with copyright requirements, as the identified or selected text 530 is never reproduced in another window or user interface outside of the context and structure of the content item.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is being claimed is:

1. A method of translating text, the method being performed by one or more processors of a computing device and comprising:
displaying, within a display area of the computing device, a portion of a text content from a content item;
identifying, from user input, a text item from the portion of the text content and a target language;
retrieving, from a network service, a translation of the identified text item in the target language; and
displaying the translation of the identified text item within a boundary of the display area and concurrently with the portion of the text content.

2. The method of claim 1, further comprising:
in response to identifying the text item, displaying, within the boundary of the display area, an icon to request translation of the identified text;
receiving a user selection of the icon; and
displaying, within the boundary of the display area, a panel that appears as part of the displayed portion of the text content.

3. The method of claim 2, wherein the panel includes a menu to enable a user to select the target language for the translation.

4. The method of claim 3, wherein the menu includes a plurality of language options that is individually selectable by the user, the plurality of language options being displayed on the panel in response to a user selection of the menu.

5. The method of claim 4, wherein the menu is configurable by the user to change at least one of (i) one or more language options, (ii) one or more translation services that is to perform a translation, or (iii) a number of language options available in the menu.

6. The method of claim 2, wherein displaying the translation includes displaying the translation within the panel.

7. The method of claim 1, wherein identifying the text item includes highlighting the text in a color that is distinguishable from a remainder of the portion of the text content.

8. The method of claim 2, further comprising:
determining a position of the selected text item; and
wherein displaying the panel includes displaying the panel within the boundary of the display area based on the position of the selected text item so as to not obscure the selected text item.

9. The method of claim 1, wherein the translation is positioned adjacent to the identified text item.

10. The method of claim 1, wherein the content item corresponds to an e-book, and wherein the portion of the text content corresponds to a page of the e-book.

11. A non-transitory computer-readable medium storing instructions that, when executed by one or more processors of a computing device, cause the one or more processors to perform operations comprising:
displaying, within a display area of a display of the computing device, a portion of a text content from a content item, the content item having a predefined structure and format;
identifying, from user input, a text item from the portion of the text content and a target language;
retrieving, from a network service, a translation of the identified text item in the target language; and
displaying the translation of the identified text item within a boundary of the display area and concurrently with the portion of the text content.

12. The non-transitory computer-readable medium storing of claim 11, wherein the instructions cause the one or more processors to further perform operations comprising:
in response to identifying the text item, displaying, on the display, an icon to request translation of the identified text;
receiving a user selection of the icon; and
displaying, within the boundary of the display area, a panel that appears as part of the displayed portion of the text content.

13. The non-transitory computer-readable medium storing of claim 12, wherein the panel includes a menu to enable a user to select the target language for the translation.

14. The non-transitory computer-readable medium storing of claim 13, wherein the menu includes a plurality of language options that is individually selectable by the user, the plurality of language options being displayed on the user interface in response to a user selection of the menu.

15. The non-transitory computer-readable medium storing of claim 14, wherein the menu is configurable by the user to change at least one of (i) one or more language options, (ii) one or more translation services that is to perform a translation, or (iii) a number of language options available in the menu.

16. The non-transitory computer-readable medium storing of claim 12, wherein the instructions cause the one or more processors to display the translation by providing the translation within the panel.

17. The non-transitory computer-readable medium storing of claim 12, wherein the instructions cause the one or more processors to further perform operations comprising:
determining a position of the selected text item; and
wherein the instructions cause the one or more processors to display the panel by displaying the panel within the boundary of the display area based on the position of the selected text item so as to not obscure the selected text item.

18. The non-transitory computer-readable medium storing of claim 11, wherein the translation is positioned adjacent to the identified text item

19. The non-transitory computer-readable medium storing of claim 11, wherein the content item corresponds to an e-book, and wherein the portion of the text content corresponds to a page of the e-book.

20. A computing device comprising:
one or more memory resources that stores instructions and one or more content items, each of the one or more content items having a predefined structure and format;
a display;
an input mechanism;
a network interface; and
one or more processors that use the instructions from the memory to:
display, within a display area of the display, a portion of a text content from a content item;
identify, from user input, a text item from the portion of the text content and a target language;
retrieve, from a network service, a translation of the identified text item in the target language; and
display the translation of the identified text item within a boundary of the display area and concurrently with the portion of the text content.
